(19) United States
(12) Patent Application Publication
(10) Pub. No.: US 2008/0205702 A1
(43) Pub. Date: Aug. 28, 2008

(54) BACKGROUND IMAGE GENERATION APPARATUS

(75) Inventor: Satoshi NAKASHIMA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/034,953

(22) Filed: Feb. 21, 2008

(30) Foreign Application Priority Data
Feb. 22, 2007 (JP) 2007-043024

(51) Int. Cl. G06K 9/78

(52) U.S. Cl. 382/103

(57) ABSTRACT

The information of a detection area is obtained by using radar, the information is sent to a mobile body detection unit, the position of a mobile body existing within the detection area is detected, a zone excluding a predetermined range surrounding the mobile body is identified by using a nonexistence zone identification unit, the information of the detection area at the time is obtained, a zone which does not include a mobile body is accurately generated by a background image generation unit, then the information of the detection area is obtained by a camera, and the difference between the generated background image and the aforementioned information is detected by a difference process unit; thereby an accurate position of the mobile body is detected.

### CROSS REFERENCE TO RELATED APPLICATIONS

This application claims priority from Japanese Patent Application No. JP2007-43024 filed on Feb. 22, 2007, which is incorporated hereinto by reference.

### BACKGROUND OF THE INVENTION

1. Field of the Invention

The present invention relates to a background image generation apparatus that is used for detecting a mobile body and that generates a background image in the detection area of a mobile body.

2. Description of the Related Art

A background differentiation method is used as a technique for detecting, for example, a vehicle on a road by using an imaging apparatus such as a camera. This method picks up an image in a detection area by using an imaging apparatus such as a camera, generates a background image, and compares the difference between the background image and an image photographed in the same detection area thereafter, thereby detecting a mobile body such as an automobile, and, unlike other methods, is capable of applying to the case of a vehicle being stationary and is widely used in preference of its simple process.

FIG. 1 is a diagram describing the background differentiation method in which the image information of a detection area 30 photographed by a camera 31 is sent to a background image generation unit 32 and a background image is generated and stored in a recording unit 33. Note that it is in a state in which a mobile body 34 does not exist in the detection area. Then, the image information of the same detection area 30 photographed by the camera 31 is transmitted to a mobile body detection unit 35 in which the mobile body 34 is extracted by performing the process of differentiating the transmission image and the background image, and the mobile body 34 is detected.

FIG. 2 is a diagram describing the process illustratively. First, the detection area 30 in a state in which a mobile body 34 such as an automobile does not exist is pre-photographed and a background image is generated. Then, the image information of the same place is photographed by the same camera 31 to make an input image, and the mobile body 34 is extracted by performing a differentiation process between the input image and the aforementioned background image.

The method described above, however, may have difficulty in obtaining a background image, depending on the road environment, thus creating a situation in which a mobile body exists in the background image. As an example, FIG. 3 is a diagram describing such a state, in which the mobile body 34a is photographed when generating the background image and the mobile body 34a that does not actually exist is included in the image extracted through the differentiation process, thus disabling an accurate process for extracting a mobile body.

Accordingly, a method is proposed for recording images for a prescribed time period in the past and generating, and updating, a background image by estimating it from the average value or median value of brightness.

Incidentally, Laid-Open Japanese Patent Application Publication No. 2003-202373 has disclosed an invention that detects a vehicle by using radar in lieu of a camera and differentiates the vehicle from other bodies on the basis of the detection result.

Further, the invention noted in Laid-Open Japanese Patent Application Publication No. 2003-299066 has disclosed a technique that employs a camera and radar, uses the camera for ordinary photographing, and uses the radar to extract an object if it is difficult to take a photo using the camera due to environmental conditions such as stormy weather.

In the case of using the conventional background differentiation method estimating the average value or median value described above, however, the premise is that the time period in which a mobile body does not exist in a detection area is sufficiently longer than the period in which a mobile body does exist therein, and the conditions are such that the appearance frequency of the mobile body is low and the stoppage time of the mobile body is short. Therefore, if the appearance frequency of the mobile body is high and if the stoppage time thereof is long, it is not possible to generate an appropriately accurate background image. For example, it is difficult to detect a vehicle accurately on a traffic-jammed road.

Note that the invention noted in Laid-Open Japanese Patent Application Publication No. 2003-202373 is configured to detect a mobile body by using only radar in lieu of using an imaging apparatus such as a camera, as noted above.

Meanwhile, the invention noted in Laid-Open Japanese Patent Application Publication No. 2003-299066 is configured to employ a camera and radar and to identify the position at which an object exists by using the radar when photography using the camera is not possible.

### SUMMARY OF THE INVENTION

One of the aspect of the present invention aims at providing a background image generation apparatus capable of generating an accurate background image even in a road jammed with vehicles and even when there exists a vehicle that is stopped for an extended time period, and that is capable of performing a process for accurately detecting a mobile body by using the background image by comprising: a mobile body detection unit for detecting position information of a mobile body existing in a predetermined measurement area by using radar; a mobile body nonexistence zone identification unit for identifying a zone in which the mobile body does not exist within the measurement area on the basis of the position information of the mobile body detected by the mobile body detection unit; an image information obtainment unit for obtaining the image information of the measurement area synchronously with the detection process of the mobile body performed by the mobile body detection unit; and a background image generation unit for generating the background information of the measurement area from both the image information obtained by the image information obtainment unit and the information identified by the mobile body nonexistence zone identification unit.

The background image generation apparatus also comprises a mobile body detection unit for performing a differentiation process between a background image generated by the background image generation unit and a new image of the measurement area obtained by the image information obtainment unit, thereby extracting a mobile body existing in the measurement area.

The mobile body nonexistence zone identification unit is also configured to perform a process for identifying a mobile body nonexistence zone on the basis of information of a preset influence exclusion margin of a mobile body.

The background image generation apparatus also comprises an exception pixel exclusion unit for removing an exceptional mobile body existing in a zone identified by the mobile body nonexistence zone identification unit.

The background image generation apparatus is further configured such that the generation of the background image results in the performance of a process for detecting a mobile body by the mobile body detection unit and a process for obtaining image information by the image information obtainment unit, and obtains the background image by synthesizing a plurality of images that are obtained as a result of repeating the aforementioned processes a plurality of times at different times.

### BRIEF DESCRIPTION OF THE DRAWINGS

FIG. 1 is a system configuration diagram of a background image generation apparatus;

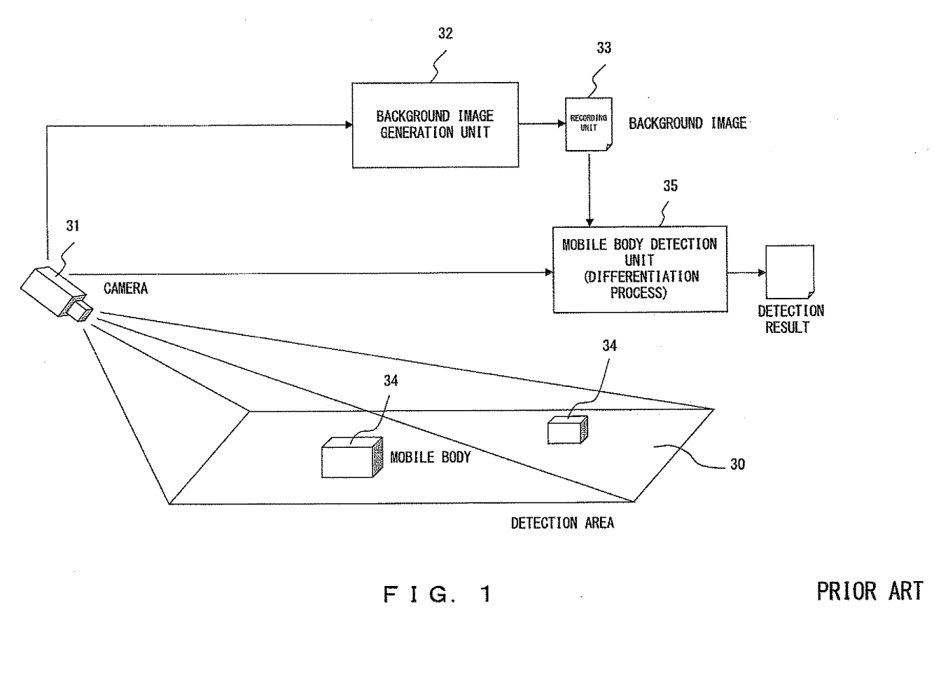

FIG. 2 is a diagram describing the process for generating a background image;

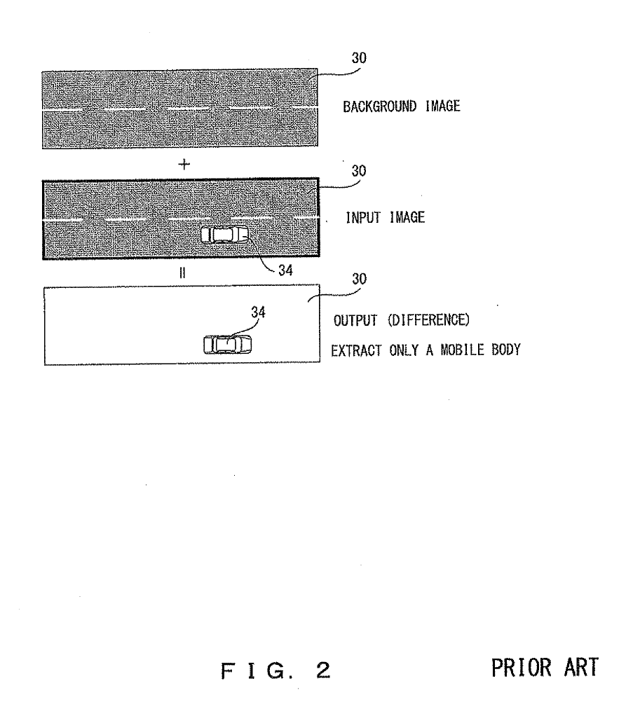

FIG. 3 is a diagram describing the problem in the process for generating a background image;

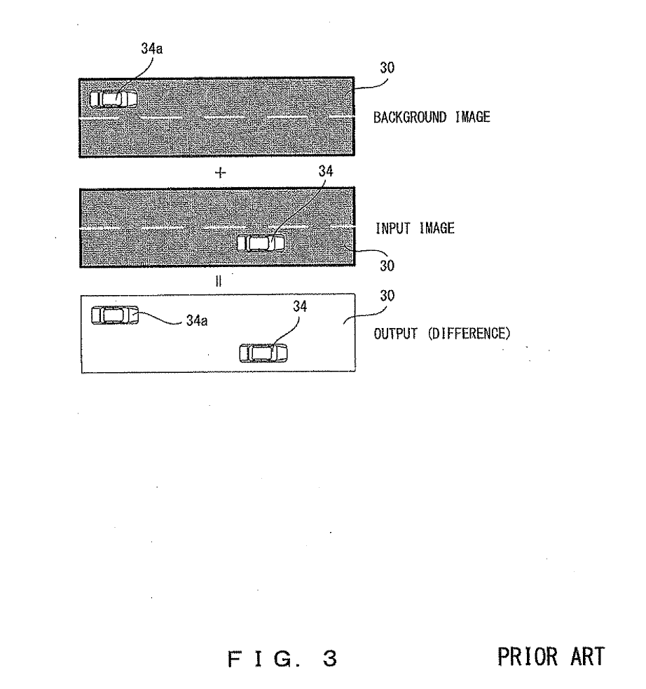

FIG. 4 is the system configuration diagram of a background image generation apparatus according to the present embodiment;

FIG. 5 is a diagram describing the specific configuration of the background image generation apparatus;

FIG. 6 is a diagram describing a process of a nonexistence zone extraction unit;

FIG. 7 is a diagram describing a process of a zone correction unit;

FIG. 8(a) exemplifies a table of laser/image coordinate conversion information, (b) is a diagram describing the image of a nonexistence zone, (c) exemplifies an image indicating a nonexistence zone including a mobile body after being converted into an image coordinate system, and (d) is a diagram exemplifying an image extracting only a nonexistence zone from an image;

FIG. 9 is a diagram describing the image of the nonexistence zone at a certain point in time;

FIG. 10 is a diagram describing the image of the nonexistence zone at another point in time;

FIG. 11A is a diagram describing the coordinate conversion of the nonexistence zone image in the process shown in FIG. 6.

FIG. 11B is a diagram describing the coordinate conversion of the nonexistence zone image in the process shown in FIG. 7;

FIG. 12(a) is a diagram showing a nonexistence zone image with a commingled mobile body, (b) and (c) are diagrams each showing a nonexistence zone image without a commingled mobile body, and (d) is a diagram showing a nonexistence zone image from which an exceptional pixel has been excluded;

FIG. 13(a) and (b) are diagrams each showing a nonexistence zone image, and (c) is a diagram showing a background image that is a result of synthesis; and

FIG. 14 is a diagram of a system configuration for performing the process of the present embodiment by using the program.

### DESCRIPTION OF THE PREFERRED EMBODIMENTS

The following is a description of the preferred embodiment of the present invention by referring to the accompanying drawings.

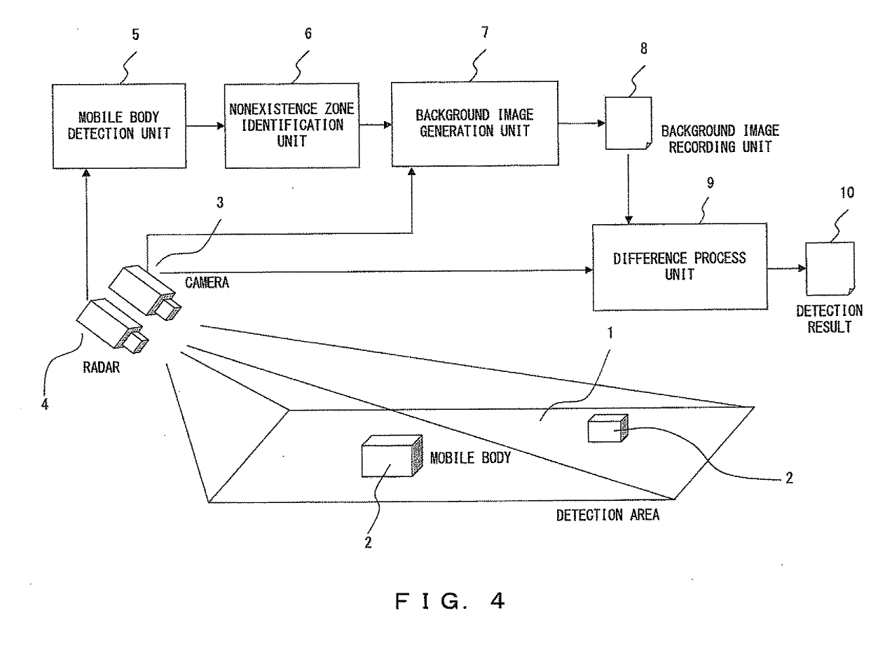

FIG. 4 is the system configuration diagram of a background image generation apparatus according to the present embodiment. The background image generation apparatus of the present embodiment is configured to confirm the position of a mobile body 2 by using radar even if the mobile body 2, such as an automobile and/or motorcycle, exists in a detection area 1, such as an expressway or a highway, and to generate a background image by picking up an image (simply noted as “imaging” hereinafter) of the state at the time by using a camera. In order to perform this, a camera 3 and radar 4 are placed on an upper side of the detection area 1, an image of the detection area 1 is obtained by using the camera 3, and the presence or absence of the mobile body 2 is confirmed by using the radar 4. Also, the distance to, and direction of, the mobile body 2 are measured when performing detection.

The background image generation apparatus of the present embodiment comprises a mobile body detection unit 5, a nonexistence zone identification unit 6, a background image generation unit 7, a background image recording unit 8, and a difference process unit 9. Meanwhile, the process performed by the difference process unit 9 obtains a detection result 10.

The camera 3 can employ various kinds of cameras such as a charge coupled device (CCD) camera, a lens-mounted camera, or the like, and the image information obtained by the camera 3 is output to the background image generation unit 7.

The mobile body detection unit 5 detects the presence or absence of the mobile body 2 on the basis of information transmitted from the radar 4 and detects the position information of the mobile body 2 from the information of the distance and direction if the mobile body 2 is detected. The mobile body detection unit 5 outputs the information to the nonexistence zone identification unit 6.

If the mobile body 2 is detected, the nonexistence zone identification unit 6 identifies a predetermined range of the surrounding of the place, where the mobile body 2 exists, as a nonexistence zone. Then, the information generated by the nonexistence zone identification unit 6 is transmitted to the background image generation unit 7 in which a background image in a state in which the mobile body 2 does not exist is generated. Further, the information generated by the background image generation unit 7 is stored in the background image recording unit 8.

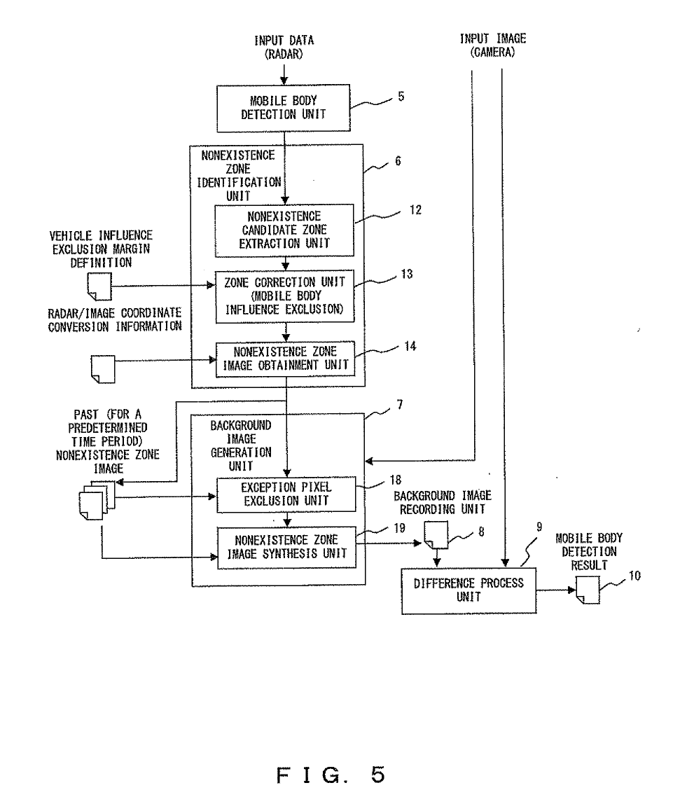

FIG. 5 is a diagram describing the specific configuration of the background image generation apparatus comprised as described above. As described above, the information of the distance and direction of the mobile body 2 measured by the radar 4 is transmitted to the mobile body detection unit 5. Here, when the transmission direction of the radar 4 is swung from the left to the right about the center position of the radar 4, the information of the direction supplied from the radar 4 is defined as a positive (+) angle if the radar is swung to the right direction and as a (−) negative angle if the radar is swung to the left direction. Further, the distance information is that of the direct distance between, for example, the installed position of the radar 4 and the tip position of the detected mobile body 2. The mobile body detection unit 5 knows the position of the mobile body 2 in the detection area 1 on the basis of the distance information and direction.

The position information of the mobile body 2 detected by the mobile body detection unit 5 is supplied to the nonexistence zone identification unit 6 which comprises a nonexistence candidate zone extraction unit 12, a zone correction unit 13, and a nonexistence zone image obtainment unit 14.

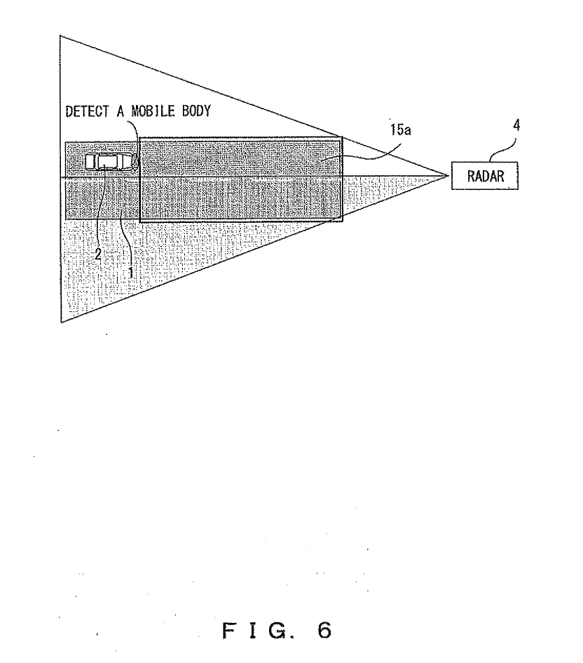

The nonexistence candidate zone extraction unit 12 extracts a zone in which the mobile body 2 does not exist on the basis of the position information of the mobile body supplied from the mobile body detection unit 5. FIG. 6 is a diagram describing the process. As shown in FIG. 6, this process determines, to be a nonexistence candidate zone 15a, the zone that is in front of (or near the side of) the position where the mobile body 2 is detected and is in the direction toward the detection area away from the installed position of the radar 4. Therefore, the zone enclosed by the solid lines within the detection area 1 is the nonexistence candidate zone 15a.

Next, the zone correction unit 13 performs a correction process considering a factor or factors influencing the nonexistence candidate zone 15a. This zone correction is a correction for excluding influences to the position of the mobile body 2 such as the influence of shadows and road surface reflections, and is carried out on the basis of a preset vehicle influence exclusion margin.

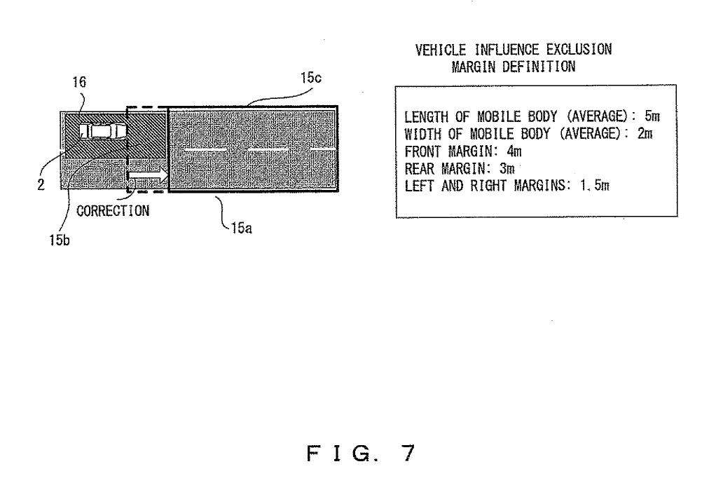

FIG. 7 is a diagram describing the process noted above. The definitions in the present embodiment are: the average length of mobile bodies (e.g., automobiles) 2 is 5 meters, the average width is 2 meters and the margin is 4 meters in front of the mobile body, the margin in the rear is 3 meters and the margins at the two sides are 1.5 meters each. In this case, the influence range of the mobile body is the zone 16 and the zone 15b overlapped with the nonexistence candidate zone 15a is eliminated from the nonexistence candidate zone 15a as shown in FIG. 17. Therefore, the obtained nonexistence zone is 15c in this case.

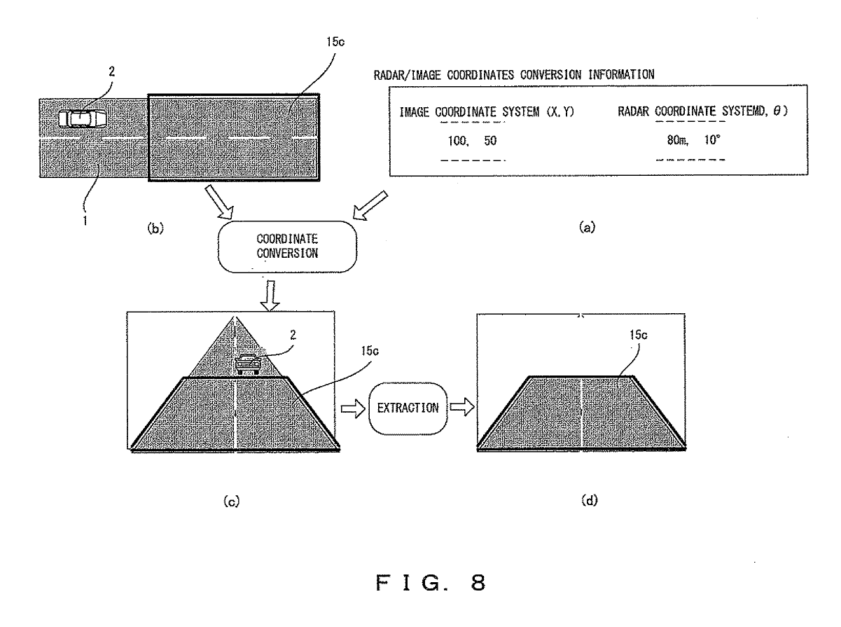

Next, the process for obtaining a nonexistence zone image is performed by the nonexistence zone image obtainment unit 14. FIG. 18 is a diagram describing the aforementioned process. This process is carried out on the basis of radar/image coordinate conversion information, and a nonexistence zone image is obtained as the image information of an image coordinate system. As an example, FIG. 8(a) exemplifies radar/image coordinate conversion information set in the form of a conversion table. In the case of the example shown in the drawing, the position information of the radar coordinate system (D, θ) 80 m and 10° is converted into the image coordinate system ((X) 100, (Y) 50). Note that many other pieces of conversion information are stored in the table, and a conversion process from the radar coordinate system into an image coordinate system is performed for each of them.

FIG. 8(c) is an image indicating a nonexistence zone 15c that includes a mobile body 2 when the radar coordinate system shown in FIG. 8(a) is converted into the image coordinate system.

Further, FIG. 8(d) shows an image in which only the nonexistence zone 15c is extracted from the image of FIG. 8 (c). The thusly generated nonexistence zone image is output to the background image generation unit 7 and is recorded as one piece of the nonexistence zone image. Note that an alternative configuration may be such that the conversion process is performed by using for example a conversion equation instead of the use of the conversion table described above.

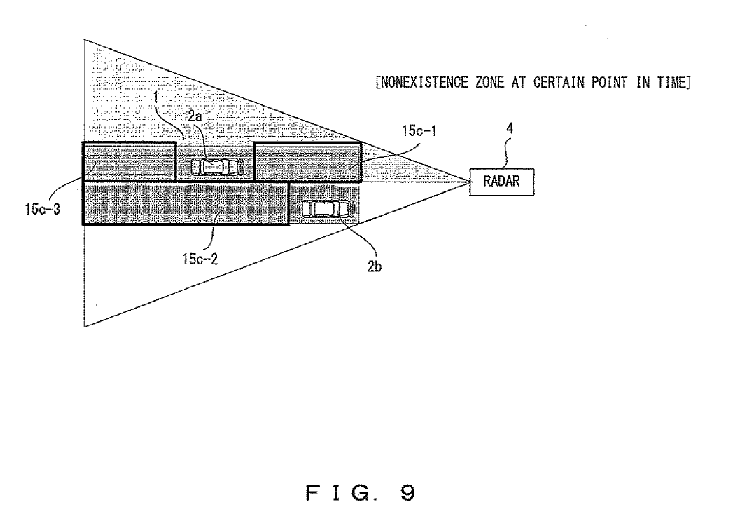

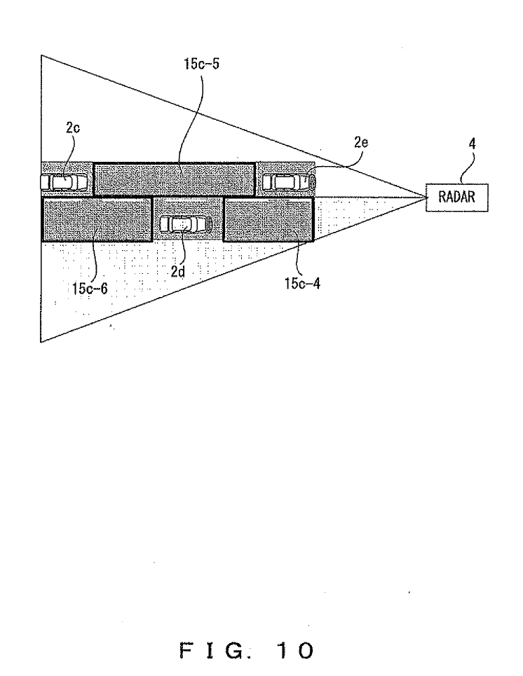

The process of obtaining the nonexistence zone image is repeated many times at various points in time, and the example shown in FIG. 9 is a diagram showing the detection of nonexistence zones at a certain point in time. In this case, two mobile bodies 2a and 2b are positioned in the detection area 1, with the nonexistence zones being 15c-1 through 15c-3. Meanwhile, the example shown in FIG. 10 is the detection of nonexistence zones at another point in time, in which three mobile bodies 2c, 2d and 2e are positioned in the detection area 1 in this case, with the nonexistence zones being 15c-4 through 15c-6.

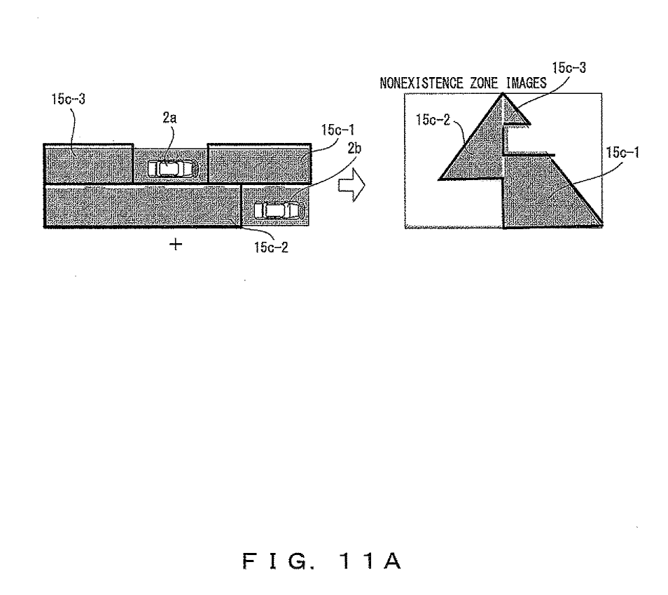

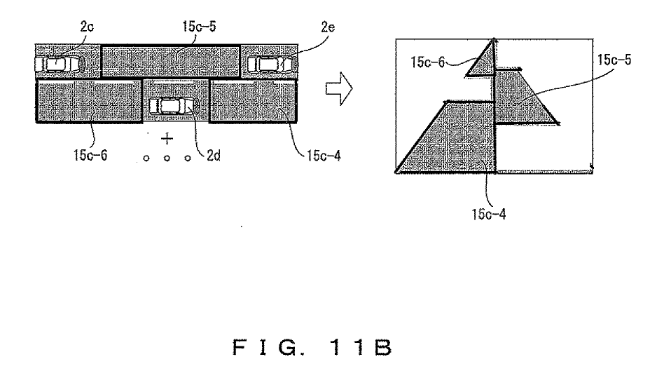

Further, FIGS. 11A and 11B show examples of converting the nonexistence zone image shown in the above described FIGS. 9 and 10 from the radar coordinate system to the image coordinate system. That is, FIG. 11A exemplifies the conversion of the image information shown in FIG. 9 into an image of the image coordinate system, and FIG. 11B exemplifies the conversion of the image information shown in FIG. 10 into the image of the image coordinate system.

Therefore, the nonexistence zone image shown in FIG. 8 (d) and that shown in FIGS. 11A and 11B are recorded in the background image generation unit 7, and the nonexistence zone images for the certain time period in the past are recorded.

The background image generation unit 7 is constituted by an exception pixel exclusion unit 18 and a nonexistence zone image synthesis unit 19, with the exception pixel exclusion unit 18 performing the process for excluding the existence of a mobile body 2, such as a light motor vehicle or a motor cycle, that has been erroneously commingled in the detection process performed by the radar 4.

Meanwhile, the nonexistence zone image synthesis unit 19 performs a synthesis process on the basis of a large number of nonexistence zone images generated by the nonexistence zone image obtainment unit 14 as described above and generates a background image.

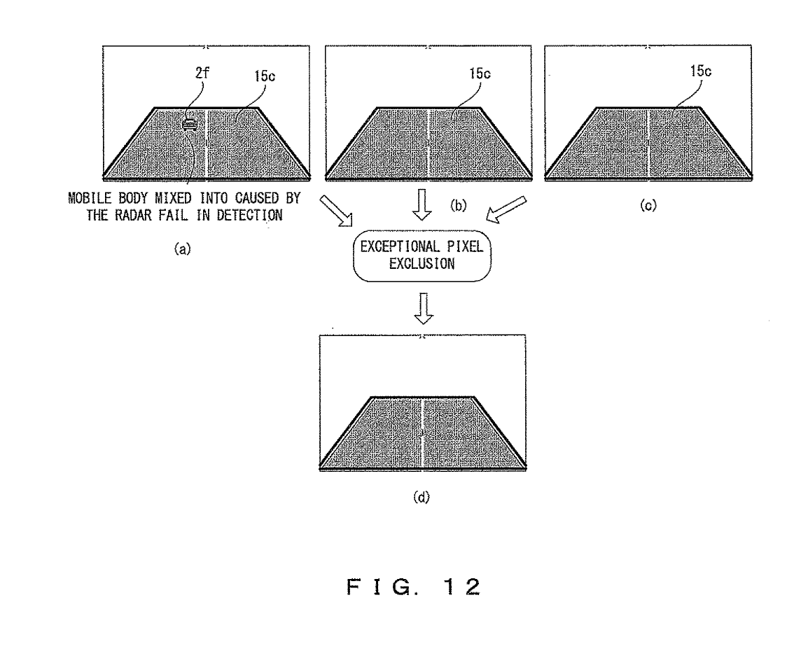

First, the process performed by the exception pixel exclusion unit 18 is described. FIG. 12 is a diagram describing the process of the exception pixel exclusion unit 18. Note that FIG. 12(a) shows the case of a mobile body 2f being commingled in the nonexistence zone image 15c due to the radar 4 failing in detection, and FIGS. 12(b) and 12(c) show nonexistence zone images 15c in which a mobile body is not commingled. Incidentally, the mobile body shown in FIG. 12(a) is defined as an exception pixel.

The exception pixel exclusion unit 18 reads the image information of the nonexistence zone image, performs an exclusion process of an exceptional image by calculating the average value or median value for each pixel, and obtains the image of FIG. 12(d), which is a result of excluding the mobile body 2f. For example, a weighted average is calculated, or a median process is performed and a process for excluding an exceptional part is performed. Specifically, in the nonexistence zone image shown in FIGS. 12(a) through (c), the brightness level of the nonexistence zone is extracted, and an exceptional pixel is excluded by calculating the average value or median value for each respective pixel.

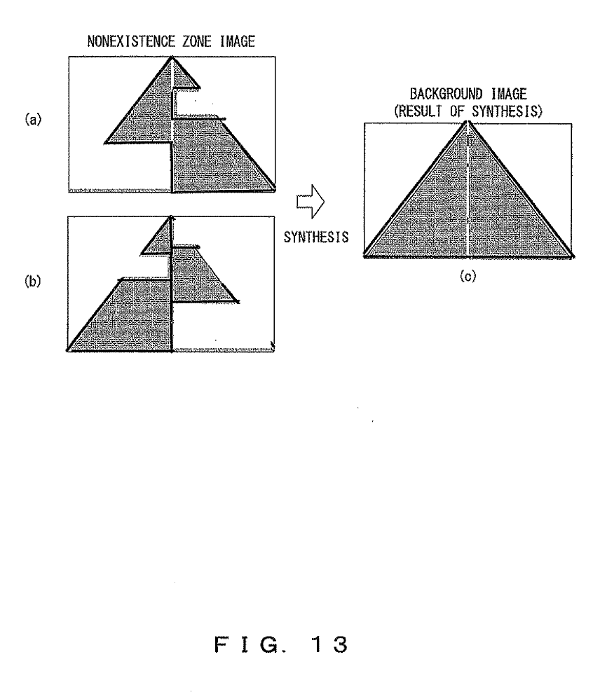

Then, the nonexistence zone image synthesis unit 19 performs a process for synthesizing a large number of recorded nonexistence zone images and generates one background image. FIG. 13 is a diagram describing the aforementioned process. The nonexistence zone images shown in FIGS. 13(a) and (b) are pieces of image information that do not have the influence of a mobile body so that a synthesis of these images makes it possible to generate a background image, which is shown in FIG. 13(c). Further, the mobile body 2f or the like erroneously picked up is excluded without causing failure in the exception pixel exclusion unit 18 as described above, and thus the generation of an accurate background image is enabled.

The thusly generated background image is recorded in the background image recording unit 8 and is used in the process for detecting a mobile body passing through the detection area thereafter. Therefore, the processing as described above makes it possible to generate a background image in which a mobile body 2 does not exist. Note that the example noted above has been described for the case of the mobile body 2 existing in the detection of a mobile body performed by the radar 4; it is alternatively possible to use image information obtained by the camera at that point as a background image without performing a process for generating the nonexistence zone image if a mobile body 2 does not exist.

Next, the information of the background image recorded in the background image recording unit 8 is sent to the difference process unit 9 and is used in a process for detecting a mobile body 2 included in the image information obtained by the camera 3 thereafter, Specifically, a process for differentiating between the background image recorded in the background image recording unit 8 and the image information obtained by the camera 3 is performed and thereby a detection result 10 of the mobile body 2 is obtained. Such a process makes it possible to detect the presence of the mobile body 2 moving in the detection area accurately on the basis of the background image. Note that the differentiation process is achieved by performing, for example, an OR addition of both of the images.

As described above, the present embodiment is configured to enable the generation of a precise background image without the commingling of a mobile body even in a detection area having a high appearance frequency of mobile bodies such as automobiles. Further, it is enabled to perform the process for detecting a mobile body accurately by using such a precise background image.

Incidentally, the distance D in the radar coordinate system measured by the radar 4 is defined as the direct distance between the installed position of the radar 4 and the mobile body 2 in the description for FIG. 8; it may alternatively be, for example, the direct distance between the position of the road surface on which the radar is installed and the mobile body 2, ascertained using the height of the installed position from the road surface.

Also, the embodiment described above employs the radar 4 for detecting a mobile body 2; any apparatus may be applied if it can detect the position of the mobile body 2, in lieu of being limited to the radar 4.

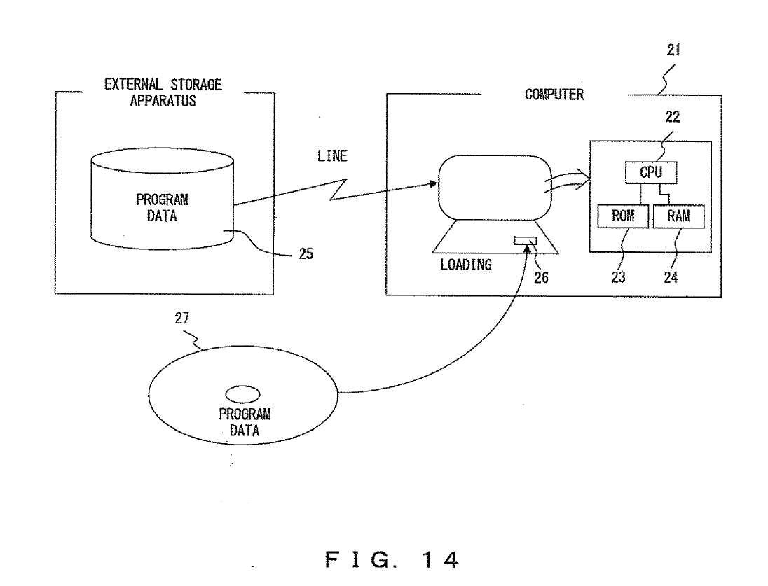

In the meantime, the background generation apparatus described above may also be constituted by using the computer shown in FIG. 14. The computer 21 comprises a central processing unit (CPU) 22, read only memory (ROM) 23, random access memory (RAM) 24 and such, with, for example, the ROM 23 storing a program to execute the various processes of the present embodiment. An external storage apparatus 25 is also connected to the computer 21 by way of a line for enabling data exchanges. A media drive apparatus 26 drives a portable recording medium 27 to access the recorded contents therein. The portable recording medium 27 can employ a discretionary computer readable recording medium such as a memory card, a floppy (registered trademark) disk, a compact disk-read only memory (CD-ROM), an optical disk, and a magneto optical disk.

The portable recording medium 27 or the ROM 23 stores the program for carrying out the above described processes, e.g., the mobile body detection process, the mobile body nonexistence zone identification process for identifying a zone in which a mobile body does not exist within the measurement area on the basis of the position information of the mobile body detected by the aforementioned mobile body detection process, the image obtainment process for obtaining the image in the measurement area synchronously with the detection of the mobile body by the mobile body detection process, and the background image generation process for generating a background image of the measurement area from both the image information obtained by the image obtainment process and the image information identified by the mobile body nonexistence zone identification process.

Therefore, the use of the program, the generation of the background image based on the information obtained from the camera 3 or radar 4, and the processing for differentiating between the background image and a newly obtained input image make it possible to perform the process for extracting the mobile body 2.

The present embodiment is configured to enable the generation of a background image at a high accuracy by not allowing commingling of a mobile body even in a detection area with a high appearance frequency of mobile bodies and to enable the process for detecting a mobile body accurately by using such a highly precise background image.

What is claimed is:

1. A background image generation apparatus, comprising:
a mobile body detection unit for detecting position information of a mobile body existing in a predetermined measurement area by using radar;
a mobile body nonexistence zone identification unit for identifying a zone in which the mobile body does not exist within the measurement area on the basis of the position information of the mobile body detected by the mobile body detection unit;
an image information obtainment unit for obtaining the image information of the measurement area synchronously with the detection process of the mobile body performed by the mobile body detection unit; and
a background image generation unit for generating the background information of the measurement area from both the image information obtained by the image information obtainment unit and the information identified by the mobile body nonexistence zone identification unit.

2. The background image generation apparatus according to claim 1, comprising
a mobile body detection unit for performing a differentiation process between a background image generated by said background image generation unit and a new image of said measurement area obtained by said image information obtainment unit, thereby extracting a mobile body existing in the measurement area.

3. The background image generation apparatus according to claim 2, wherein
position information of a mobile body detected by said mobile body detection unit is used in a process for identifying a zone in which the mobile body does not exist after the aforementioned position information is converted from the radar coordinate system into an image coordinate system.

4. The background image generation apparatus according to claim 1, wherein
said mobile body nonexistence zone identification unit performs a process for identifying a mobile body nonexistence zone on the basis of information of a preset influence exclusion margin of a mobile body.

5. The background image generation apparatus according to claim 1, comprising
an exception pixel exclusion unit for removing the existence of an exceptional mobile body existing in a zone identified by said mobile body nonexistence zone identification unit.

6. The background image generation apparatus according to claim 1, wherein
the generation of said background image results in the performance of a process for detecting a mobile body by said mobile body detection unit and a process for obtaining image information by said image information obtainment unit, and obtains the background image by synthesizing a plurality of images which are obtained as a result of repeating the aforementioned processes a plurality of times at different times.

7. The background image generation apparatus according to claim 2, wherein
said mobile body detection unit performs an OR addition process of said background image and a new pickup image which is obtained by said image information obtainment unit, thereby performing a process for detecting a mobile body.

8. A background image generation apparatus, comprising:
a mobile body detection unit for detecting position information of a mobile body existing in a predetermined measurement area by using radar;
an image information obtainment unit for obtaining the image information of the measurement area synchronously with the detection process of the mobile body performed by the mobile body detection unit;
a background image setup unit for setting image information obtained by the image information obtainment unit as background information if the mobile body is not detected by the mobile body detection unit within the measurement area;
a mobile body detection unit for performing a differentiation process between a background image and a new image within the measurement area that is obtained by the image information obtainment unit, thereby extracting a mobile body existing in the measurement area.

9. A background image generation method, comprising:
a mobile body detection process for detecting position information of a mobile body existing in a predetermined measurement area by using radar;
a mobile body nonexistence zone identification process for identifying a zone in which the mobile body does not exist within the measurement area, on the basis of the position information of the mobile body detected by the mobile body detection process;
an image information obtainment process for obtaining the image information of the measurement area synchronously with the detection process of the mobile body performed by the mobile body detection process; and
a background image generation process for generating the background information of the measurement area from both the image information obtained by the image information obtainment process and the image information identified by the mobile body nonexistence zone identification process.

10. The background image generation method according to claim 9, performing
a mobile body detection process for performing a differentiation process between a background image generated by said background image generation process and new image information of said measurement area obtained by said image information obtainment process, thereby performing a mobile body extraction process for extracting a mobile body existing in the measurement area.

11. A computer readable medium, comprising:
a mobile body detection process for detecting position information of a mobile body existing in a predetermined is measurement area on the basis of information measured by using radar;
a mobile body nonexistence zone identification process for identifying a zone in which the mobile body does not exist within the measurement area, on the basis of the position information of the mobile body detected by the mobile body detection process;
an image information obtainment process for obtaining the image information of the measurement area synchronously with the detection process of the mobile body performed by the mobile body detection process; and
a background image generation process for generating the background information of the measurement area from both the image information obtained by the image information obtainment process and the image information identified by the mobile body nonexistence zone identification process.

12. The medium according to claim 11, performing
a mobile body detection process for performing a differentiation process between a background image generated by said background image generation process and new image information of said measurement area obtained by said image information obtainment process, thereby performing a mobile body extraction process for extracting a mobile body existing in the measurement area.
